(19) United States
(12) Patent Application Publication
(10) Pub. No.: US 2021/0086852 A1
(43) Pub. Date: Mar. 25, 2021

(54) Mid-Motor Three Wheel Drive Three Wheel Vehicle

(71) Applicants: Gregory W. Kunsch, Virginia Beach, VA (US); Alexander Andre Kunsch, Virginia Beach, VA (US)

(72) Inventors: Gregory W. Kunsch, Virginia Beach, VA (US); Alexander Andre Kunsch, Virginia Beach, VA (US)

(21) Appl. No.: 16/578,370

(22) Filed: Sep. 22, 2019

(51) Int. Cl. B62D 61/06; B60K 1/02; B60K 7/00; B62D 31/00; B60L 15/20

(52) U.S. Cl. CPC B62D 61/065; B60K 1/02; B60K 2007/0061; B62D 31/003; B60L 15/2009; B60K 7/0007

(57) ABSTRACT

The general layout for a three wheel drive, three wheel vehicle with two steerable driven wheels in the front of the vehicle, utilizing one or two motors to drive the front wheels, and a rear motor to drive the rear wheel. The vehicle maximizes performance of a three wheel vehicle by controlling torque on all three wheels. This is used to manage vehicle lateral dynamics while maximizing wheel traction for acceleration. Utilizing compact motors, in-hub motors, or direct connect motors allows a significant portion of the vehicle's weight to be moved forward, while integrating the location of the passenger seating, steering, and driven wheels results in a highly stable three wheel vehicle. The layout maintains the traditional bucket or bench style seats as found in today's automobiles, and yet allows for weighting and cockpit adaptability for different market demographics.

### BACKGROUND

### Field of the Invention

The present invention pertains to motor vehicles. More specifically, the present invention pertains to those having only three wheels.

### Description of the Related Art

Three wheel vehicles come in a variety of types, whether two wheels in rear, two wheels in front, driven rear wheel(s), or driven front wheel(s). These types are well articulated in U.S. Pat. No. 9,604,683 (patent citation #1) and are exemplified in numerous vehicles and patents today. The present invention introduces Type 4A as follows:
Type-1—Two wheels in the rear of the vehicle with the rear wheels driven.
Type 2—Two wheels in the front of the vehicle with the rear wheel driven. Variations of this are:
   (A) Straddle type seating where the vehicle body or motor is straddled by the passenger, whether the motor is directly underneath, forward, or rearward of the driver. An example is a Can-Am Spyder (non-patent citation #1).
   (B) Traditional seating with the motor in front of the passenger compartment. Examples include Polaris Slingshot (non-patent citation #2) and Morgan 3. Wheeler (non-patent citation #3).
   (C) Traditional seating with the motor behind the passenger seat. An example is the Campagna T-Rex (non-patent citation #4).
Type 3—Two wheels in the front of the vehicle with the front wheels driven. Variations of this are:
   (A) Straddle type seating where the body or motor is straddled by the passenger, whether the motor is directly underneath, forward, or rearward of the driver. An example is the Stimson Scorcher (non-patent citation #5).
   (B) Traditional seating with the motor in front of the passenger compartment. An example is the Trihawk (non-patent citation #6). This is referred to as ‘front engine’ design.
   (C) Traditional seating with the motor behind the front of passenger seat. This is referred to as a ‘rear engine’ design.
      (1) Rear wheel steering. An example is the Dymaxion car (non-patent citation #7).
      (2) Front wheel steering. An example is U.S. Pat. No. 9,604,683 (patent citation #1).
   (D) Traditional seating with the motor in the mid-section of the vehicle, between the front of the passenger compartment and the front of the passenger seat. This type is referenced as ‘mid-engine’ design.
Type 4—Two wheels in the front of the vehicle with three wheels driven.
   (A) Traditional seating with one or two electric motors in the mid or rear section of the vehicle driving the front wheels, and one electric motor in the rear section of the vehicle driving the rear wheel. This type is referenced as the three-wheel drive mid-motor design.
   (B) Other variations including:
      vehicles with the motor or motors located in forward portion of vehicle,
      vehicles with straddle type seating,
      vehicles utilizing mechanical means to distribute power between the front and rear wheels.

U.S. Pat. No. 9,604,683 (patent citation #1) describes the stability challenges with various types of three wheel vehicles.

Unlike previous art, the present invention utilizes three driven wheels, placing the front motor or motors in-line with the passenger compartment, and the rear motor in the rear section of the vehicle, centering the vehicle weight for optimal stability.

The present invention retains the passengers towards the front, over widest part of the vehicle. The largest weight variable is the number and size of the passengers. With the present invention, changes in the center of gravity for the vehicle due to loading variability are minimized and occur in the mid-section near the widest portion of the vehicle. This unique vehicle approach results in a stable three wheel vehicle design.

The present invention uses separate front and rear motors to balance power delivery and manage desired traction levels between the front and rear of the vehicle. This balance of power is a crucial element of the present invention. In U.S. Pat. No. 9,604,683 (patent citation #1), the use of front wheel drive enhances traction characteristics by eliminating all power to the rear wheel. Eliminating all power to the rear wheel is not necessary in all cases. In the present invention, effectively balancing power to the rear wheel allows the rear wheel to be used in a controlled and optimized manner in addition to the driven front wheels.

Although no previous art could be found, it is anticipated that other art will likely employ three driven wheel designs utilizing two or three motors, with the front motors in the front of the vehicle forward of the passenger compartment. Designs of this nature will have challenges developing optimum weight distribution between the front and rear wheels. Anticipated art of this approach will cause the passenger compartment to be pushed rearward, and the resulting center of gravity will likely be too far back for optimal performance. This is significantly different than the present invention where the passenger compartment is pulled forward. Although no previous art could be found, this art is mentioned to contrast the present invention, and is referred to as anticipated previous art.

### SUMMARY OF THE INVENTION

The present invention defines a unique three wheel vehicle where the wheels are arranged with two in the front of the vehicle and one in the rear. All three wheels are driven. The front wheels are driven by placing the one or two electric motors in the midsection or rear of the vehicle and driving the front wheels. The rear wheel is driven by a single electric motor in the rear of the vehicle. A typical embodiment would be an electric motor driving each front wheel, with the center of the wheels placed just forward of the passenger seats and parallel to the passenger compartment, and a single rear motor in the rear of the vehicle. Single, dual or multiple passenger variants are possible within the mid-motor configuration.

### DESCRIPTION OF THE SEVERAL VIEWS OF THE DRAWING

Present Invention Drawings are as follows:

Drawing (1): Embodiment: Single Passenger seating; Three Motor

FIG. 1—Embodiment—Perspective View—fully sketched exterior

FIG. 2—Embodiment—Plan View—cutaway showing key elements

Drawing (2): Embodiment: Dual Passenger with Side by Side seating; Dual Motor

FIG. 3—Embodiment—Plan View

Drawing (3): Depiction of motor location with respect to vehicle section (Front/Mid/Rear) contrasting

Present invention and Anticipated Previous art

FIG. 4—Plan View

On each of the drawings, items called out are as follows:
(A)—Front Wheels
(B)—Passenger Seats
(C1)—Motor(s) Front
(C2)—Motors(s) Mid/Rear
(C3)—Motors(s) Rear
(D)—Rear Wheel
(E)—Passenger Compartment
(F)—Motor to Driven wheel connection
(G)—Vehicle Section

Before any embodiments of the invention are explained in detail, it is to be understood that the invention is not limited in its application to the details of construction and the detailed arrangement of components set forth in the following description or illustrated in the following drawings. The invention is capable of other embodiments not listed herein, and of being practiced or of being carried out in various ways. Also, it is to be understood that the phraseology and terminology used herein is for the purpose of description and should not be regarded as limiting.

### DETAILED DESCRIPTION OF THE INVENTION

FIG. 2 portrays the general layout of the components of the present invention within a single passenger, three motor embodiment. Regardless of the number or type of motors, and number or arrangement of seats, there are key components which define the present invention. The key components are two steerable front wheels (item A), a rear wheel (item D) which is located behind the front wheels, a passenger compartment (item E) with one or more conventional passenger seats (item B), and one or more motors (item C2) overlapping the mid-section or rear of the vehicle which drive the front wheels, and a motor in the rear of the vehicle (item C3) driving the rear wheel.

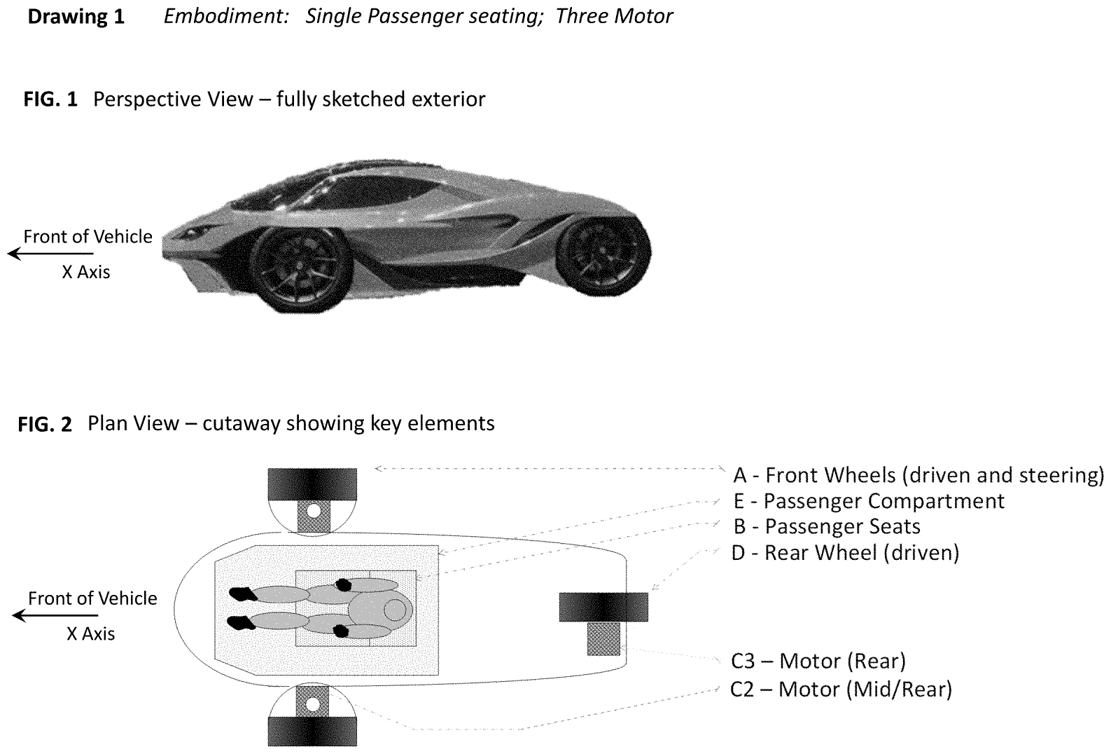

FIG. 1 portrays a fully sketched perspective view of the exterior of a single passenger three motor embodiment. The exterior styling is not a critical or key component of the vehicle functions and may take many forms dependent on the target market.

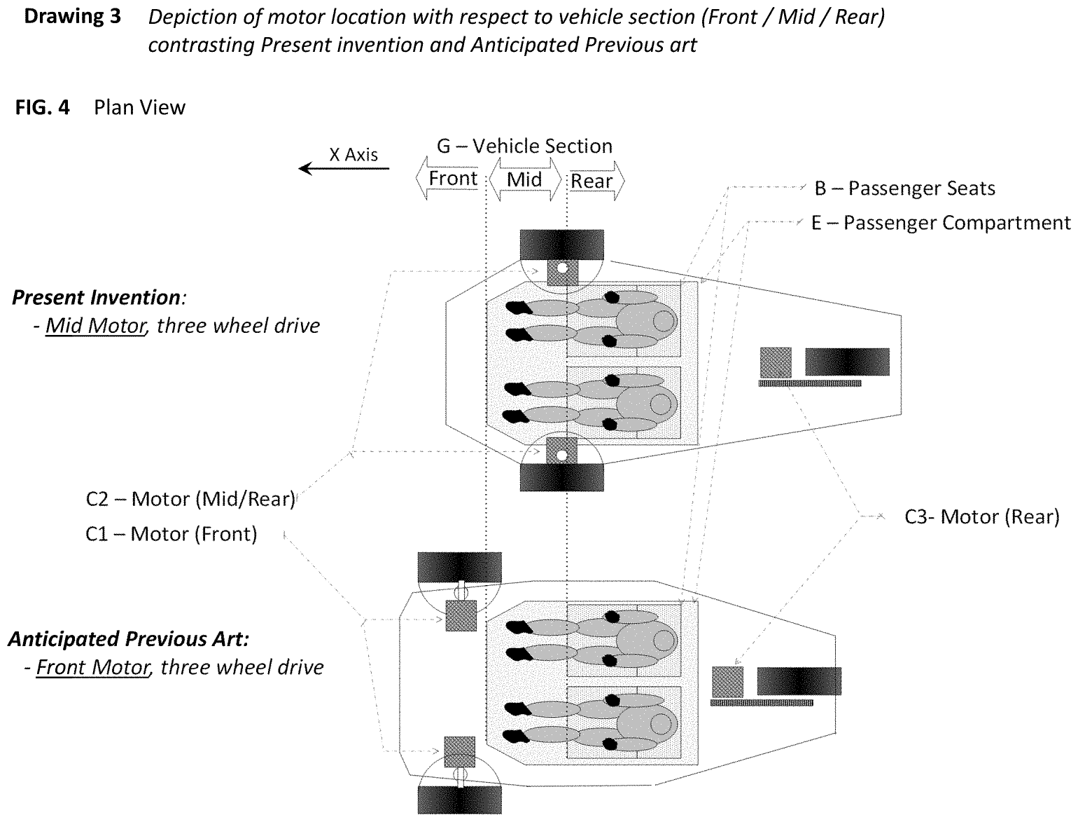

FIG. 4 is a depiction of motor locations with respect to vehicle section (Front/Mid/Rear) contrasting Present invention and Anticipated Previous art in a plan view. There are three sections of the vehicle (item G), the front, mid, and rear which are defined along the x-axis of the vehicle. The passenger compartment (item E) is the area of the vehicle intended for the passengers. The passenger compartment is the area in which the passengers sit and encompasses the passenger seats (item B). The X axis is the centerline of the vehicle extending from the front to the rear.
The front section is the area of the vehicle extending forward of the passenger compartment.
The mid-section is the area of the vehicle extending from the front of the seat to the front of the passenger compartment. If there are multiple seats, then mid-section is defined by the front of the forward most seat.
The rear section is the area of the vehicle extending from the front of the seat to the rear of the vehicle. If there are multiple seats, then rear section is defined by the front of the forward most seat.

There are one or two electric motors which drive the front wheels. The front motor is in a location that overlaps or partially overlaps the mid-section or rear of the vehicle. This does not imply that the motor must be in or part of the passenger compartment. The motor may be within or external to the passenger compartment itself. The overlap along the X axis may be full or partial. A full overlap is when the entire motor is within the mid-section plane of the vehicle. A partial overlap is when any portion of the motor overlaps the mid-section plane. Regardless of the amount of overlap, any overlap with the mid-section of the vehicle defines the vehicle as mid-motor and is within the context of the present invention. The mid-section overlap articulates the mid-motor design of the present invention.

There is one electric motor in the rear section of the vehicle driving the rear wheels. The front and rear motors are not mechanically connected to drive both the front and rear wheels; the front motor or motors drive the front wheels, and the rear motor drives the rear wheel.

FIG. 4 contrasts the present invention from other possible art. The anticipated previous art in FIG. 4 shows the front motors in front of the passenger compartment, and thus in the front section of the vehicle. The present invention places the front motors in the mid-section of the vehicle, resulting in completely different vehicle dynamics. This is very important on a three wheel vehicle where weight and handling characteristics are crucial to the vehicle stability.

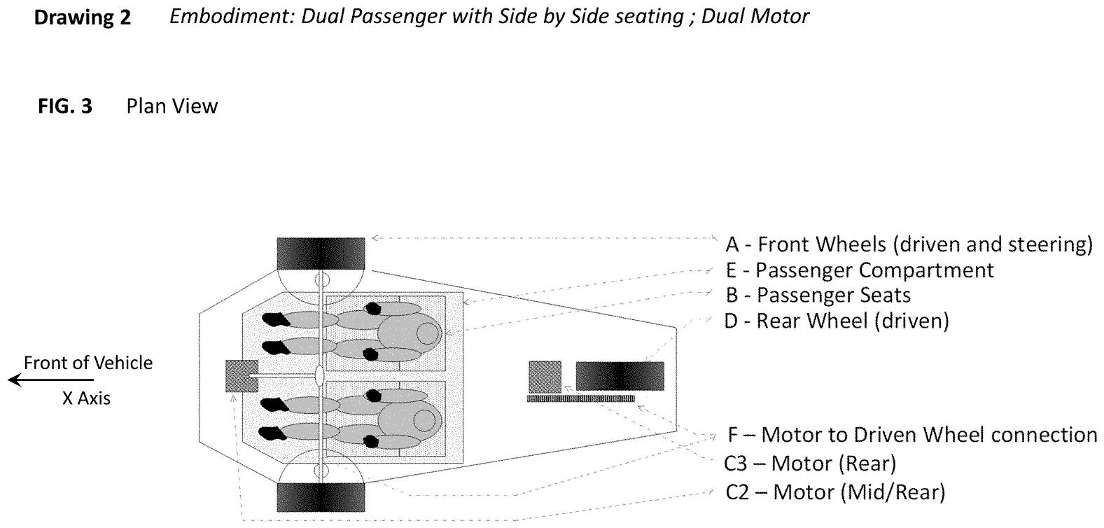

FIG. 3 is an embodiment showing Dual Passenger with Side by Side seating, Dual Motor, in a Plan view. Similar to FIG. 2, key elements are shown: two steerable front wheels (item A), a rear wheel (item D) which is located behind the front wheels, a passenger compartment (item E) with one or more conventional passenger seats (item B), and one or more motors (item C2) overlapping the mid-section or rear of the vehicle which drive the front wheels, and a motor in the rear of the vehicle (item C3) driving the rear wheel. Additionally, a motor to driven wheel connection (item F) is shown on the rear wheel.

The present invention may utilize a variety of motor to driven wheel connection types (item F) and is not limited by possible types. Example connection types may include chain, belt, hydraulic, shaft, or direct. The method used to connect the motor to the wheels is not critical to the intent of the present invention. In certain embodiments, such as an in-hub motor, there may not be any additional connections required between motor and wheel.

If seating is adjustable, references to ‘front of seat’ indicate the forward most position of the seat. If multiple seats are used, the ‘front of seat’ refers to the seat in the forward most position in the vehicle.

The present invention is limited to standard sit-in or sit-on type passenger seats (Item B), which is also referred to as ‘traditional’ seating. The present invention does not extend to vehicles with straddle seating, in which the passenger has one leg or foot on either side of the motor or primary body of the vehicle, regardless of whether the passenger is in a forward leaning, vertical, rearward leaning, reclined, or horizontal position. Straddle type seating may have the motor directly underneath, forward, or rearward of the driver.

The present invention is limited to electric motors. There are several key factors in the present invention related to electric motors. First, the weighting of the electric motor represents a key facet of the present invention; compact motor sizes allow weight to be moved more incrementally. Second, electrically balancing power is critical to performance; attempting to balance multiple internal combustion motors would be challenging. Third, the electric motor's ability to drive both forward and backward from the same motor is important in the present invention vehicle dynamics. It is important to understand that references to ‘driven wheel’ represent torque driving the vehicle forward or rearward. The electric motor may drive the wheel forward to accelerate the vehicle, or rearward in a braking fashion. This ability to use the electric motors in both directions allows stability to be optimized in the present invention. An embodiment may only use the rear wheel in deceleration modes. Conversely, other embodiments may use a smaller motor in the rear for limited wheel torque in straight line acceleration, and no torque while the vehicle is in a turn. The specific embodiment used within the present invention will rely on each vehicle's key weights such as motor size and battery location, and desired performance characteristics whether high performance or utilitarian.

In addition to items noted above, the present invention is not limited by:
frame or body structure type or material.
distances between items.
classification of vehicle such as motorcycle or car.
construction details.
suspension types and variations.
body types.
other vehicle components.

While this invention has been described with several embodiments, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A three wheel vehicle comprising:
two front wheels which allow primary directional control of the vehicle;
a single rear wheel;
a passenger compartment, the compartment comprising one or more traditional passenger seats;
one or two electric motors located in the mid or rear section of the vehicle, driving the front wheels either directly or indirectly, providing forward torque for acceleration or rearward torque for deceleration of the wheels;
one electric motor located in the rear section of the vehicle, driving the rear wheel either directly or indirectly, providing forward torque for acceleration or rearward torque for deceleration of the wheel.
